(19) United States
(12) Patent Application Publication
(10) Pub. No.: US 2017/0181453 A1
(43) Pub. Date: Jun. 29, 2017

(54) COMPOSITION COMPRISING CASEIN FIBRILS

(71) Applicant: NESTEC S.A., Vevey (CH)

(72) Inventors: Christophe Joseph Etienne Schmitt, Servion (CH); Daniel Baier, Berlin (DE); Dietrich Knorr, Berlin (DE)

(21) Appl. No.: 15/312,982

(22) PCT Filed: May 6, 2015
(86) PCT No.: PCT/EP2015/059998

§ 371 Date: Nov. 21, 2016

(30) Foreign Application Priority Data
May 28, 2014 (EP) 14170208.4

(51) Int. Cl. A23L 2/66; A23P 30/40; A23J 3/24; A23L 3/015; A23C 9/154; A23J 3/08

(52) U.S. Cl. CPC A23L 2/66; A23C 9/154; A23J 3/08; A23J 3/245; A23L 3/0155; A23P 30/40; A23V 2002/00

(57) ABSTRACT

The present invention relates to protein compositions. In particular, the invention relates to a method for the production of a composition comprising casein fibrils. Further aspects of the invention area composition comprising casein fibrils, the use of such a composition and a food product comprising the composition.

The present invention relates to protein compositions. In particular, the invention relates to a method for the production of a composition comprising casein fibrils. Further aspects of the invention are a composition comprising casein fibrils, the use of such a composition and a food product comprising the composition.

Fibrillar aggregates of globular proteins such as β-lactoglobulin have been used in food products as texture modifiers. WO2004/049819 describes a method for improving the functional properties of globular proteins. WO2013/087354 describes using mixtures of protein aggregates comprising fibrillar aggregates of globular proteins together with another structure of protein aggregate, such as worm-like aggregates or spherical aggregates to improve the foam stability of aerated food products. However, a disadvantage with fibrillar aggregates of globular proteins is that the fibrils need to be generated either by acid incubation of protein dispersions, for example at pH 2.0 for several hours, or by enzymatic treatments. Neither is particularly convenient industrially.

It would be advantageous to provide an alternative food texture modifier, produced from readily available starting materials by a rapid and efficient method.

An object of the present invention is to improve the state of the art and to provide a solution to overcome at least some of the inconveniences described above or at least to provide a useful alternative. Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The object of the present invention is achieved by the subject matter of the independent claims. The dependent claims further develop the idea of the present invention.

The present invention provides in a first aspect a method for the production of a composition comprising casein fibrils, the method comprising
a) preparing an aqueous mixture comprising micellar casein and optionally whey proteins, wherein the ratio of micellar casein to whey protein is greater than 1 on a weight basis, the pH of the aqueous mixture is between 5.0 and 9.0, the micellar casein is present at a level of between 0.5 and 10 wt. % in the aqueous mixture and the mixture contains less than 5 wt. % fat,
b) pressurizing the aqueous mixture at a pressure of more than 200 MPa absolute,
c) cooling the aqueous mixture to a temperature below its freezing point measured at atmospheric pressure while the pressure is kept above 200 MPa absolute,
d) releasing the pressure to a level below 0.2 MPa absolute while the temperature is kept below the aqueous mixture's freezing point measured at atmospheric pressure, and
e) increasing the temperature of the aqueous mixture to above its freezing point measured at atmospheric pressure.

In a second aspect, the invention relates to a composition comprising casein fibrils obtainable by the method of the invention. Other aspects of the invention relate to a food product comprising the composition of the invention and the use of the composition of the invention to modify the texture of a food product.

It has been surprisingly found by the inventors that, when a dispersion of micellar caseins is submitted to high pressure-low temperature treatment (HPLT) and then thawed, fibrillar aggregates are formed. These aggregates have shear thickening behavior and can be used to stabilize foams, for example against drainage or air coalescence. The same treatments applied to whey protein isolate solutions or with sodium caseinate (no casein in a micellar state) did not lead to the formation of fibrillar aggregates.

Proteins play a major role as functional ingredients in food as they offer the potential to create and stabilize disperse systems like foams, emulsions and gels. It is generally accepted that small changes in the molecular structure like refolding or disulfide exchanges can induce large changes in the functional behavior of proteins. Hence, high pressure treatments, which favour reactions with negative reaction volume, provide the opportunity to modify protein structures and so alter their functional properties. In addition to the effect of pressure, HPLT treatments may lead to protein modification due to cold denaturation and effects caused by ice crystallization. The subzero temperature domain of the phase diagram of water enables different freezing processes.

HPLT processes allow on the one hand freezing of water to higher ice modifications (pressure assisted freezing—PAF) and on the other hand instantaneous freezing to atmospheric ice by decompression at subzero temperature (pressure shift freezing—PSF). An overview of HPLT process options and their nomenclature is given by Urrutia Benet [G. Urrutia Benet et al., Innovative Food Science & Emerging Technologies, 5, 413-427 (2004)].

In pressure assisted freezing, an unfrozen sample is frozen at high pressure and the temperature gradient between the cooling medium and the sample is the driving force for the freezing process. This process allows freezing of water to three different ice modifications (ICE I, III and V) within the relevant pressure range. These ice modifications differ in their crystal structure and consequently in their density, see FIG. 1. (Data in FIG. 1 is taken from Bridgman [P. W. Bridgman, Proceedings of the American Academy of Arts and Sciences, 48, 450-558 (1912)] and Fletcher [N. H. Fletcher, Other forms of ice, The Chemical Physics of Ice: Cambridge University Press (1970)]). Examples of two process paths for PAF are shown on FIG. 1 as A-B-E-H and A-F-G-H. The only ice modification with a lower density than liquid water is ICE I (frozen water at atmospheric pressure). This means that a recrystallization to ICE I during the decompression leads to a high volume change and, thus, to an additional mechanical stress on any protein present. In pressure shift freezing the sample is cooled down under pressure without nucleation and the phase transition to ICE I occurs during the decompression. This instantaneous nucleation leads to a homogeneous size distribution of very small ice crystals which may impact any protein present. An example process path for PSF is shown on FIG. 1 as A-B-C-D.

### BRIEF DESCRIPTION OF THE DRAWINGS

FIG. 1 shows a Phase diagram of water with HPLT process options—A-B-C-D: Pressure shift freezing; A-B-E-H and A-F-G-H: Pressure assisted freezing to ICE III and V. The lower part of the figure shows the volume changes during phase transitions.

FIG. 2 shows selected FPIA pictures of some very large flocks in pure micellar casein (MC) dispersions after HPLT treatments.

FIG. 3 shows the results of size and shape analyses of MC containing samples after pressure treatments at different temperatures (HP, PSF, PAF) obtained via Flow Particle Image Analysis (FPIA).

FIG. 4 shows flow curves for shear experiments in a rotational rheometer with a single gap cylinder at 20° C. (ramp to 500 1/s in 60 s, 60 s at 500 1/s, ramp to 0 1/s in 60 s). Exemplary pictures of large flocks are given within the graphs.

### DETAILED DESCRIPTION OF THE INVENTION

The present invention relates in part to a method for the production of a composition comprising casein fibrils, the method comprising
a) preparing an aqueous mixture comprising micellar casein and optionally whey proteins, wherein the ratio of micellar casein to whey protein is greater than 1 on a weight basis, the pH of the aqueous mixture is between 5.0 and 9.0, the micellar casein is present at a level of between 0.5 and 10 wt. % in the aqueous mixture and the mixture contains less than 5 wt. % fat,
b) pressurizing the aqueous mixture at a pressure of more than 200 MPa absolute,
c) cooling the aqueous mixture to a temperature below its freezing point measured at atmospheric pressure while the pressure is kept above 200 MPa absolute,
d) releasing the pressure to a level below 0.2 MPa absolute while the temperature is kept below the aqueous mixture's freezing point measured at atmospheric pressure, and
e) increasing the temperature of the aqueous mixture to above its freezing point measured at atmospheric pressure.

Casein fibrils are protein aggregates having a mostly linear structure. The method steps of the invention induce the formation of casein fibrils, both as single fibrils and also as fibrous flocks of casein. The fibrous flocks of casein may contain other proteins as minor components. These flocks have an elongated shape, they may for example have a circularity of less than 0.85 as measured by flow particle image analysis. Without wishing to be bound by theory, it is believed that the formation of ice crystals may provide a surface onto which the micellar caseins can adsorb and thus be modified; the application of high pressure may promote the modification of the protein structure (promoting hydrogen and hydrophobic interactions); and freeze concentration may enhance interactions between proteins.

The aqueous mixture in the method of the invention contains less than 5 wt. % fat. In the context of the invention, the fat may be solid or liquid (e.g. an oil) at room temperature. The presence of an excessive amount of fat may lead to caseins in the aqueous mixture becoming absorbed at the surface of the fat which interferes with the formation of casein fibrils. The aqueous mixture may contain less than 1 wt. % fat, for further example less than 0.1 wt. % fat.

The presence of some whey proteins was found to promote the formation of casein fibrils and casein-based fibrillar aggregates by enhancing interactions. The ratio of micellar casein to whey proteins in the aqueous mixture of the method of the invention is greater than 1 on a weight basis, for example the ratio of micellar casein to whey proteins may be greater than 2 on a weight basis, for example the ratio of micellar casein to whey proteins may be greater than 20 on a weight basis. The aqueous mixture may have no whey protein, although in practice it is difficult to produce such a mixture at a sensible price as most casein ingredient has some whey protein present as an impurity.

The level of pressure applied may increase the degree of protein modification as well as altering the ice crystal forms which can be achieved during the HPLT process. The aqueous mixture may be pressurized to a pressure of more than 250 MPa absolute in step (b) of the method of the invention and then cooled in step (c) to a temperature below the freezing point of the aqueous mixture (measured at atmospheric pressure) while the pressure is kept above 250 MPa absolute.

Moving from neutral pH to a more acidic pH decreases the effect of the HPLT process on the casein protein. The pH of the aqueous mixture in the method of the invention is between 5.0 and 9.0, for example between 5.5 and 8.5, for further example between 5.5 and 7.5. The pH may be controlled by the addition of a buffer. In the present invention, the term buffer includes any material added to control pH, not just a classical buffer of a mixture of a weak acid and its conjugate base, or vice versa.

It is convenient to be able to process a significant amount of micellar casein into fibrils using the method of the invention. However, aqueous mixtures with high levels of micellar casein may form gels and be difficult to process. The micellar casein may be present at a level of between 0.5 and 10 wt. % in the aqueous mixture, for example between 1 and 8 wt. %, for further example between 1 and 5 wt. %. At least 50 wt. % of the casein may be present as micellar casein, for example at least 80 wt. % of the casein may be present as micellar casein, for further example at least 95 wt. % of the casein may be present as micellar casein.

The presence of components other than micellar casein and whey proteins may alter the effectiveness of the method in generating casein fibrils. For example, solutes such as sugar or lactose may alter the freezing properties of the mix and modify the protein environment, so affecting the formation of casein fibrils. The aqueous mixture of the method of the invention may consist of micellar casein, water and optionally whey proteins and optionally a buffer. For example the aqueous mixture of the method of the invention may consist of micellar casein, water, whey proteins and a buffer. For further example the aqueous mixture of the method of the invention may consist of micellar casein, water and whey proteins. For further example the aqueous mixture of the method of the invention may consist of micellar casein, water and a buffer.

The micellar casein may be provided from any known dairy source. When preparing the aqueous mixture of the invention the skilled person will have no difficulty in choosing ingredient combinations which provide micellar casein at the required ratio with whey proteins if present. The micellar casein may be comprised within an ingredient selected from the group consisting of skimmed milk, milk proteins concentrate, milk proteins isolate, micellar casein isolate and mixtures of these. One advantage of the invention over, for example, preparing fibrillar aggregates of globular proteins, is that casein proteins are readily available. The whey proteins may be comprised within an ingredient selected from the group consisting of skimmed milk, sweet whey, whey protein concentrate, whey protein isolate and mixtures of these.

In a further embodiment the present invention pertains to a composition comprising casein fibrils obtainable by the method of the invention. The method provides casein having a unique structure which has not previously been reported, and this structure leads to useful functional properties of the protein. The method of the invention provides casein-based fibrillar protein aggregates. These aggregates can be created at quite low protein concentration and build large volume particles with low protein content.

In a further embodiment, the invention provides a food product comprising the composition of the invention. For example, the method of the invention may further comprise the step of incorporating the aqueous mixture obtained in step (e) in a food product. Compositions comprising casein fibrils have a shear thickening behaviour which makes them suitable for modifying the texture of food products. The compositions comprising casein fibrils also provide good foaming and foam stability when used in foods. At least 5 wt. % of the protein in the food product of the invention may be provided by the composition obtainable by the method of the invention, for example at least 10 wt. %, for example at least 20 wt. %, for further example at least 50 wt. %. Not all the casein in in the composition obtainable by the method of the invention may be in the form of fibrils. The food product of the invention may contain casein fibrils at a level of at least 1 wt. % of the total protein in the food product, for example at least 5 wt. %, for example at least 10 wt. %, for further example at least 20 wt. %.

Although there is a limit to the amount of fat which can be present in the aqueous mixture during the production of the fibrils, once formed they may be used in higher fat systems such as food products containing fat. The foods products comprising the composition of the invention are not particularly limited in form. For example the food product may be a confectionery product, culinary product, beverage, pet food or nutritional formula.

The food product of the invention may be an aerated food product. The aerated food product according to the invention may be selected from chilled or shelf-stable dairy products such as mousse desserts; beverages such as coffees; culinary products such as souffles, dressings or sauces, shelf-stable confectionery products such as bakery products, meringues, nougat, or filled chocolate confectionery; and frozen confectionery products such as ice cream, sorbet, mellorine, frozen yoghurt, milk ice, slush, frozen beverages or frozen desserts. Incorporating the composition comprising casein fibrils in these applications not only provides good foaming and foam stability but also advantageously allows optimizing the food product final appearance and texture. In the aerated food product of the invention, at least 10 wt. % of protein may be present in the form of casein fibrils, for example at least 20 wt. %.

The composition comprising casein fibrils obtainable by the method of the invention may be used to modify the texture of a food product. The composition may be used to increase the viscosity of the food product, for example the composition may be used to increase the viscosity of the food product by at least 10% measured in mPa.s at the same shear rate between 1 and 50 s⁻¹. The composition of the invention may be added to food or drinks which are to be consumed by dysphagia sufferers to make the food or drink easier to swallow.

The composition may be used to stabilize a foam structure in the food product. For example the composition may be used as a foaming agent so that beating or whipping an aqueous system comprising the composition results in the formation of a stable foam. The composition may be used together with other foaming agents. Many foamed food products traditionally use egg white as a foaming agent, for example meringues, mousses and nougat. However, egg white may be problematic to use in food factories due to issues of microbiological contamination and smell. Other proteins are available as foaming agents, but they often do not match the functionality of egg white. It is advantageous that the invention provides an alternative foaming agent which has a higher foamability than egg white.

Those skilled in the art will understand that they can freely combine all features of the present invention disclosed herein. In particular, features described for the product of the present invention may be combined with the method of the present invention and vice versa. Further, features described for different embodiments of the present invention may be combined. Where known equivalents exist to specific features, such equivalents are incorporated as if specifically referred to in this specification. Further advantages and features of the present invention are apparent from the figures and non-limiting examples.

### EXAMPLES

### Example 1

### High Pressure-Low Temperature Treatment Induced Structural Changes in Micellar Caseins and Whey Proteins

Structural changes in micellar caseins and whey proteins due to high pressure-low temperature treatments were investigated and compared to changes caused by high pressure treatments at room temperature. Single micellar casein (MC) dispersions, single whey protein isolate (WPI) solutions, and mixtures with a weight mixing ratio of MC:WPI=80:20 or 20:80 (w/w) and a concentration of 2% (w/w) were treated at a pressure of 500 MPa for 20 min at room temperature, −15° C. (pressure shift freezing) or −35° C. (pressure assisted freezing). Samples were treated at pH 7.0 and pH 5.8.

Micellar casein powder (MC) in an almost native state was obtained from the Hungarian Dairy Research Institute (MPI-85 MC, Hungarian Dairy Research Institute, Mosonmagyaróvár, Hungary). These micelles were manufactured by microfiltration and ultrafiltration of skimmed milk. The powder contained 85.1% (w/w) protein (N×6.38), 1.5% (w/w) fat, 4.9% (w/w) water and 7.5% (w/w) ash. Whey protein isolate powder (WPI) was obtained from Fonterra (WPI 895, Fonterra, Auckland, New Zealand). This WPI is obtained by ion exchange and ultrafiltration of sweet whey. The protein content of the powder was (N×6.38) 92.63% (w/w), furthermore it contained 0.18% (w/w) fat, 5.87% (w/w) moisture and 1.6% (w/w) ash.

The MC dispersions were prepared by giving a specific amount of powder to preheated deionized water (50° C.), stirring it for 1 h and gently homogenizing it in a high pressure homogenizer (ElmusiFlex-C5, Avestin, Inc., Ottawa, Canada) at a maximum pressure of 30 MPa. The WPI solutions were prepared by diluting a specific amount of powder in deionized water and stirring it for 1 h at room temperature. Protein dispersions were prepared on a w/w ratio and pH values were either 7.0 (native) or set to 5.8 by use of 1 M HCl and NaOH (Merck KGaA, Darmstadt, Germany). The samples were double packed in polyethylene (PE) pouches to strictly avoid a penetration of the PTM (pressure transmitting medium). All samples were freshly prepared and kept at 4° C. until analysed.

The HPLT treatments were conducted in an experimental HPLT unit containing a high pressure vessel with 265 mL volume (Sitec Sieber AG, Zurich, Switzerland) connected to a DS XHW-1373 air driven high pressure pump (Haskel, Calif., USA). The vessel is equipped with a heating-cooling jacket and temperature control was realized with a cryostat (Ultra-Kryomat RUK 50-D, Lauda, Germany). An 80% (v/v) ethanol water mixture was used as a temperature transfer medium as well as pressure transmitting medium (PTM, freezing point below −59° C.). Two type K thermocouples enabled temperature measurements of the PTM at the bottom of the vessel and inside of a sample at the top of the vessel. The pressure was measured with a pressure transducer (Intersonde HP28, Watford, England). The samples were thawed at room temperature before further preparations or analysis.

A flow particle image analysis (FPIA) was used to characterize large protein flocks and aggregates after HPLT treatments. The applied equipment was a FPIA 3000 (Sysmex Corporation, Kobe, Japan) with a 5× magnification lens. Particles were measured in the low power field (LPF). Samples were directly injected into the sheath fluid (Particle sheath, Sysmex Corporation, Kobe, Japan) in the sample inlet and after an automatic dilution of the device the measurement was performed. The equivalent spherical diameter and the maximum distance were used as size parameters of the samples and the circularity and the aspect ratio for the evaluation of the shape of the particles.

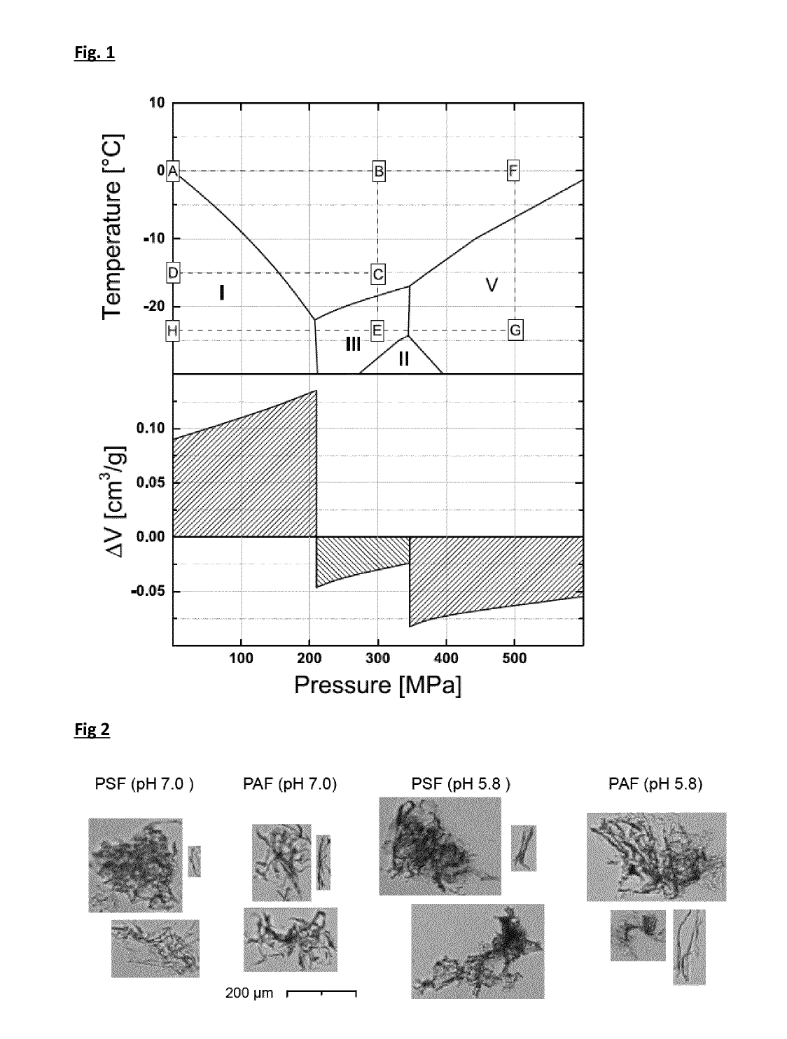

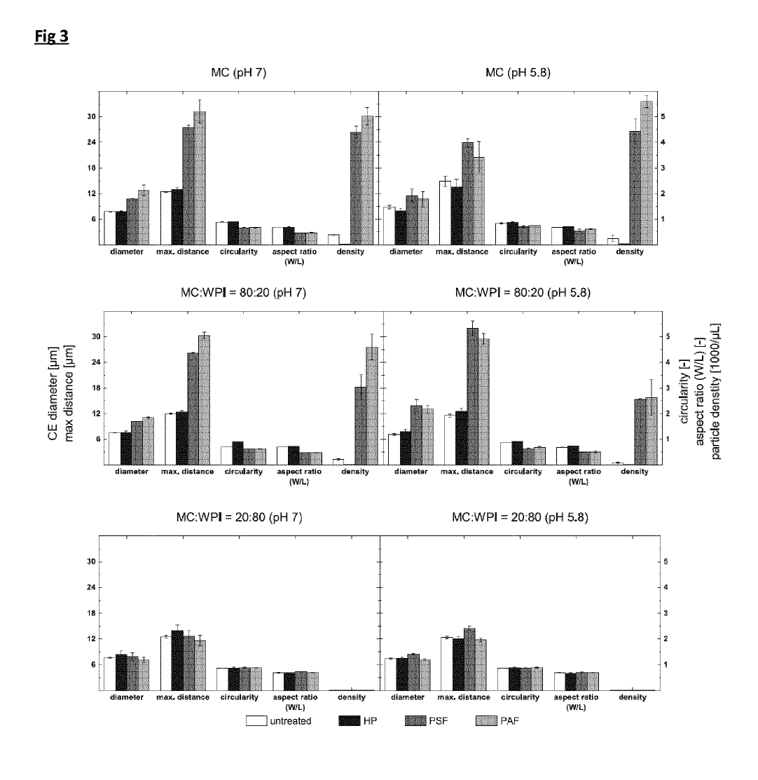

HPLT treated casein-containing samples always contained some large flocks. Some exemplary pictures of very large flocks are presented in FIG. 2. It can be seen that the flocks are aggregates of long fibers. Both single fibers and large flocks can change the functional behavior of the proteins. FIG. 3 shows the results of the size and shape analyses of MC containing samples after treatments. It is clear that only HPLT treatments caused an increase of the size displayed by an increased diameter. Applying high pressure at room temperature (HP) produces samples having a markedly lower maximum distance than when freezing is applied (PSF and PAF). This demonstrates that pressure treatment in combination with freezing is required to produce fibrils. The formed flocks have an almost elongated shape which is denoted by the strong increase in the maximum distance of about a factor of 2 at pH 7.0 and a decrease in the circularity from about 0.9 to about 0.65. The high increase in the particle density up to 5,000 particles per microliter for single MC dispersions depicts the creation of a large amount of fibrillar particles in the measurement range. However, a high proportion of MC seems to be necessary to create a significant amount of large flocks. This fact is indicated by the very low particle density of HPLT treated mixtures with a low amount of MC (MC:WPI=20:80). Repeating the HPLT treatment described above with skimmed milk powder or milk protein concentrate (both having a MC:WP ratio of 80:20) led to the formation of casein fibrils. However, no fibrils were obtained when WPI alone was treated under these conditions.

### Example 2

### Rheological Behavior

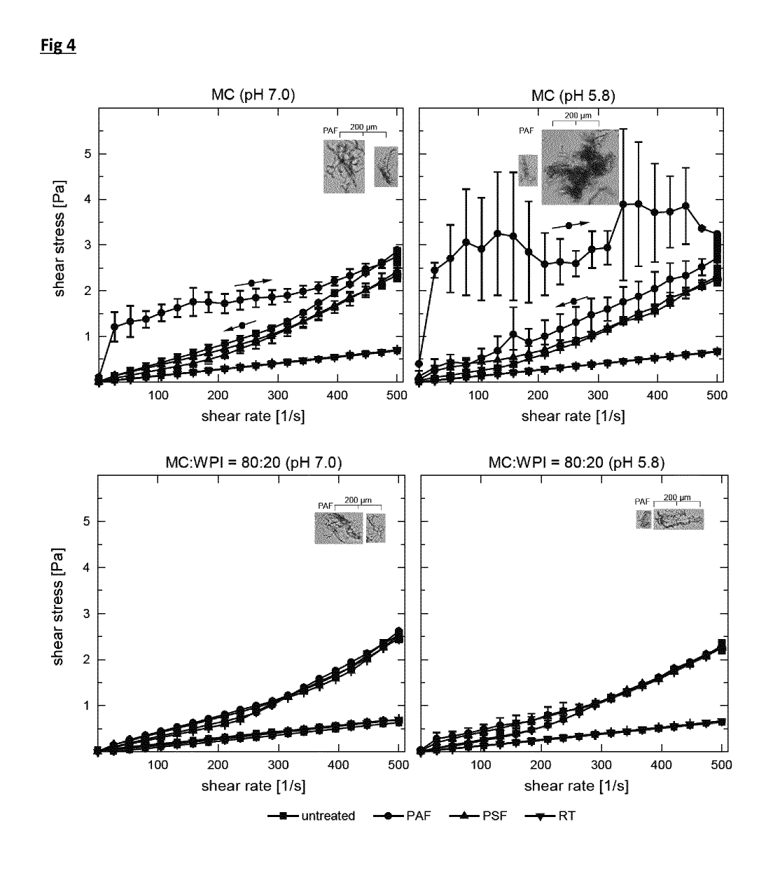

Samples with high MC content (single MC, MC:WPI=80:20 dispersions) contained large flocks with an average equivalent spherical diameter of about 12 μm after HPLT treatments. Shear experiments of all samples were performed and are shown in FIG. 4. A MCR 301 rotational viscometer with a CC 27 single gap cylinder (Anton Paar GmbH, Ostfildern-Scharnhausen, Germany) was used to analyze the rheological properties. The single gap cylinder had a gap of 1.13 mm and a sample volume of 19.35 mL. Shear experiments were performed at 20° C. with a linear ramp of 60 s up to 500 1/s, a dwell time of 60 s at 500 1/s and a ramp of 60 s to 0 1/s. Shear experiments were performed in duplicate. A clear effect on flow behavior was observed for single MC dispersions after PAF treatments. This effect was enhanced at pH 5.8 in comparison to pH 7.0. The large standard deviation values indicate some heterogeneity of the samples which can be due to the presence of flocks which are larger than the rheometer gap that was used. This was also confirmed by the decrease of shear stress at a constant shear rate which denotes a partial disaggregation of these flocks. Consequently, a hysteresis was found for these two samples. Interestingly, PAF and PSF treatments of all samples with a high MC content led to structures which show a shear thickening effect while untreated and samples treated at room temperature show a Newtonian behavior. This shows that HPLT treatments are able to induce new structures in comparison with HP treatments at room temperature. Especially, the pictures of the flocks from pure MC dispersion show a dense structure which indicates the formation of a gel-like network. Within all the pictures of the flocks a large number of single and linked fibrillar structures can be found. The particle size distribution of the flocks is quite broad and it seems that especially the largest particles contribute to the rheological behavior. This rheological behavior may advantageously be used to modify the texture of a food product.

### Example 3

### Comparative Example of Foamability and Stability

To exemplify the functional benefits of casein fibrils obtained by the method of the invention, a comparative example of foamability and foam stability has been carried out using egg white proteins as a benchmark foaming agent. The PAF HPLT treatment of Example 1 (−35° C., 500 MPa, 20 min) was used to produce casein fibrils in MC and MC:WPI (80:20) dispersions at 2 wt. % and a pH of 7.0. The same samples without HPLT treatment were used as controls. For comparison, an egg white protein dispersion was prepared at 2 wt. % protein content using egg white powder (OVOBEST Eiprodukte GmbH & Co. KG, Neuenkirchen, Germany) at its native pH of about 9.0. An amount of 4 wt. % of sucrose was then added at room temperature to each protein dispersion; HPLT treated (casein fibrils), untreated or egg white. A volume of 40 mL of each sample was then poured in 250 mL glass beaker and whipped using a kitchen mixer (AKA RG 28, Germany) for a duration of 2 minutes. The volume of foam produced after whipping (foamability) as well as the volume of foam remaining after 30 minutes (relative to initial foam volume) at room temperature were determined. Results are presented in Table 1.

TABLE 1
Foamability and stability of 2 wt. % protein dispersions
with 4 wt. % sucrose after whipping for 2 minutes and
storage for 30 minutes at room temperature.

| Sample | Foam volume [mL] | Stability 30 min [%] |
|---|---|---|
| Egg white | 47.5 ± 9.57 | 100.00 ± 0.00 |
| MC untreated | 32.5 ± 3.54 | 100.00 ± 0.00 |
| MC HPLT | 89.0 ± 5.66 | 92.76 ± 1.92 |
| MC: WPI untreated | 47.5 ± 10.61 | 100.00 ± 0.00 |
| MC: WPI HPLT | 95.0 ± 7.07 | 87.78 ± 0.63 |

It can be seen from results presented in table 1 that the HPLT-treated micellar casein containing dispersions had an improved foamability compared to egg white and the samples that were not HPLT treated. Hence, samples containing casein fibrils produced according to the method of the invention were able to produce about 2 times more foam volume compared to egg white. It is likely that the shear thickening behaviour of the casein fibril leads to better entrapment of air in the continuous aqueous phase. Foams with high air fractions are more prone to destabilization by drainage or bubble coalescence, but the casein fibril-containing samples show a high stability considering that the air fraction in these foams was almost double that in the control samples. The compositions containing casein fibrils obtained by the method of the invention formed foams which still had a volume almost twice that of the egg white foam after standing for 30 minutes.

1. Method for the production of a composition comprising casein fibrils comprising
a) preparing an aqueous mixture comprising micellar casein wherein the pH of the aqueous mixture is between 5.0 and 9.0, the micellar casein is present at a level of between 0.5 and 10 wt. % in the aqueous mixture and the mixture contains less than 5 wt. % fat;
b) pressurizing the aqueous mixture at a pressure of more than 200 MPa absolute;
c) cooling the aqueous mixture to a temperature below its freezing point measured at atmospheric pressure while the pressure is kept above 200 MPa absolute;
d) releasing the pressure to a level below 0.2 MPa absolute while the temperature is kept below the aqueous mixture's freezing point measured at atmospheric pressure; and
e) increasing the temperature of the aqueous mixture to above its freezing point measured at atmospheric pressure.

2. A method according to claim 1 wherein the aqueous mixture comprises micellar casein, water and whey protein.

3. A method according to claim 1 wherein the micellar casein comprises an ingredient selected from the group consisting of skimmed milk, milk proteins concentrate, milk proteins isolate, micellar casein isolate and mixtures thereof.

4. A method according to claim 1 wherein the whey proteins comprise an ingredient selected from the group consisting of skimmed milk, sweet whey, whey protein concentrate, whey protein isolate and mixtures thereof.

5. Composition comprising casein fibrils obtainable by
a) preparing an aqueous mixture comprising micellar casein, the pH of the aqueous mixture is between 5.0 and 9.0, the micellar casein is present at a level of between 0.5 and 10 wt. % in the aqueous mixture and the mixture contains less than 5 wt. % fat;
b) pressurizing the aqueous mixture at a pressure of more than 200 MPa absolute;
c) cooling the aqueous mixture to a temperature below its freezing point measured at atmospheric pressure while the pressure is kept above 200 MPa absolute;
d) releasing the pressure to a level below 0.2 MPa absolute while the temperature is kept below the aqueous mixture's freezing point measured at atmospheric pressure; and
e) increasing the temperature of the aqueous mixture to above its freezing point measured at atmospheric pressure.

6. Composition of claim 5 comprising a food product.

7. Composition according to claim 6 wherein the food product is an aerated food product.

8. Composition according to claim 6 wherein the food product is selected from the group consisting of chilled or shelf-stable dairy products, beverages, culinary products, shelf-stable confectionery products and frozen confectionery products.

9. A method for modifying the texture of a food product comprising adding to the food product a composition comprising casein fibrils obtainable by preparing an aqueous mixture comprising micellar casein, the pH of the aqueous mixture is between 5.0 and 9.0, the micellar casein is present at a level of between 0.5 and 10 wt. % in the aqueous mixture and the mixture contains less than 5 wt. % fat; pressurizing the aqueous mixture at a pressure of more than 200 MPa absolute; cooling the aqueous mixture to a temperature below its freezing point measured at atmospheric pressure while the pressure is kept above 200 MPa absolute; releasing the pressure to a level below 0.2 MPa absolute while the temperature is kept below the aqueous mixture's freezing point measured at atmospheric pressure; and increasing the temperature of the aqueous mixture to above its freezing point measured at atmospheric pressure.

10. Method according to claim 9 wherein the viscosity of the food product is increased.

11. Method according to claim 9 wherein a foam structure in the food product is stabilized.
